(19) United States
(12) Patent Application Publication
(10) Pub. No.: US 2002/0075128 A1
(43) Pub. Date: Jun. 20, 2002

(54) ELECTRICAL RESISTOR WITH AT LEAST TWO CONNECTION CONTACT FIELDS ON A CERAMIC SUBSTRATE

(76) Inventors: KARLHEINZ WIENAND, ASCHAFFENBURG (DE); KARLHEINZ ULLRICH, GROSSUMSTADT (DE); MARGIT SANDER, KARLSTEIN (DE); STEFAN DIETMANN, HAITERBACH (DE)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(21) Appl. No.: 09/328,106

(22) Filed: Jun. 8, 1999

(30) Foreign Application Priority Data
Jun. 9, 1998 (DE) 198 25 596.9

(51) Int. Cl. H01C 3/04

(52) U.S. Cl. 338/25

(57) ABSTRACT

An electrical resistor having an electrically insulating substrate has a planar conductor path, which is electrically and mechanically firmly connected to the substrate by at least two spaced-apart base portions arranged on the substrate, and the conductor path is provided at its ends with connection contact fields in the respective areas of the base portions. The electrical resistor is preferably used as a temperature-dependent measuring resistor having rapid responsiveness for measurement of through-flow gas streams in motor vehicle engine applications.

### BACKGROUND OF THE INVENTION

The invention relates to an electrical resistor, in particular a temperature-dependent measuring resistance with a rapid response, having a conductor path, which has at least two connection contact fields arranged on an electrically insulating surface of a substrate. A part of the conductor path spans at least one area of the substrate in a bridge-like fashion, and the conductor path is arranged in a plane. The invention also relates to a process for making the electrical resistor.

From European published patent application EP 0 446 667 A2 a temperature sensor is known having a substrate, which is transparent in the optically visible waveband, wherein the electrically conducting layer includes a plurality of meandering conductor paths in a measuring window, and wherein the substrate is preferably made of glass or quartz. The conductor paths preferably consist of consecutive layers of chromium-nickel-chromium, of platinum, of indium tin oxide, of antimony tin oxide, or of a single atom-thick passivated thin gold layer. This is a very expensive device which, in addition, can function only within a relatively narrow temperature range.

From German published patent application DE 39 27 735 A1 a temperature measuring device (radiation thermometer) is known having a temperature-sensitive thin-film resistance, applied in a meander form on a plastic foil, which spans a recess of a substrate material. The substrate is a printed circuit board or a support of epoxy resin. Such a temperature-measuring device is suited only for use in an environment with temperatures below 200° C., due to the low thermal stability of the plastic.

Furthermore, from German published patent application DE-OS 23 02 615 a temperature-dependent electrical resistor is known made of a resistance material, which forms a wound conductor path as a thin layer, which is applied to a thin foil. The foil, which is made of a polymeric plastic, has its non-coated side spanning a recess of a support member, which is made, e.g., of copper, and the recess has the same configuration as the conductor path and is aligned with it, as seen in the direction perpendicular to the plane of the foil. This arrangement concerns a temperature-measuring device, which requires a high technological effort to ensure the necessarily precise overcoating of the conductor path and the recess.

From German patent DE 30 15 356 C2 it is known that electric circuits made by thick-film technology, preferably on ceramic plate-like substrates, are manufactured by printing with pastes whose active materials consist of metal powders, glass or glass ceramic powders or mixtures of glass and metal oxides. For manufacture of fast-response sensors for temperature measurements, temperature-dependent thick-film resistances are applied to unsupported layers, which are built up with the help of filler materials gasifiable under the effect of temperature and applied by paste printing, and span a recess which is formed later. This constitutes a relatively expensive process.

Furthermore, from German published patent application DE 38 29 765 A1 and U.S. Pat. No. 4,906,965 a platinum temperature sensor is known, in which a platinum resistance path with at least two ends is applied to a surface of at least one ceramic substrate. For making this sensor, a platinum conductor path is applied in the form of meandering zigzag element to the inner surface of a ceramic sheet, which is then formed into a roll, wherein notches and alignment bridges are provided between adjacent points of the conductor path element for purposes of alignment. The ceramic substrate is fired together with the applied platinum resistance. The platinum resistance is made resistant to the surrounding atmosphere and humidity by sealing measures. In addition, after the alignment, the through holes and conductors required hereby are sealed with a ceramic coating or glass paste. The problem arising with such an arrangement is the relatively high heat capacity, which does not permit a fast response with sudden changes in temperature, and an exact measured value can only be obtained again after expiration of a transition function.

Another construction of a resistance element used as a rapid-response temperature probe is known from German published patent application DE 38 29 195 A1. There, the resistance element is in the form of a film resistance made of a platinum paste, which is deposited in a blister made of glass ceramic, which is shaped on an electrically insulating ceramic substrate. The problem in this case is operation of an unsupported resistor film under mechanical loads, e.g., shocks, pressure, and vibrations, when used in a severe application environment.

Further, from published PCT application WO 95/10770 a catalytic detector for combustible gases is known, in which a heating element, a temperature-measuring element in the form of a resistance film, and a catalytic element coupled to the measuring element are provided on a silicon substrate, wherein the area of the substrate underneath the measuring structure is etched away. The etching operation makes this a cost-intensive manufacturing process. In addition, the platinum film provided for the temperature measurement, must be protected from the silicon substrate by means of a diffusion barrier of SiO₂. Furthermore, given the massively formed substrate sides, a rapid thermal response of the measuring resistance is problematic.

### SUMMARY OF THE INVENTION

An object of the invention is to provide resistances for rapid-response temperature sensors, which are not sensitive to external mechanical loads and which are suitable in particular for sensors designed for sudden temperature changes in gas flows in a temperature range of −100 to +500° C. Furthermore, these temperature sensors for rapid gas flow measurement should be built with microstructures having a reaction time in the range of milliseconds, and in addition should be attainable at a favorable manufacturing cost.

This object is achieved according to an arrangement in which the conductor path is firmly connected to the substrate by means of at least two base portions spaced from each other. A special advantage is a long service life of the sensor. In addition, the sensor manufacture is relatively simple, and the sensor has a small size.

In a preferred embodiment of the invention, the substrate is made of ceramic, preferably aluminum oxide; the base portions are made of metal, preferably copper or nickel; and the base portions are mechanically attached to the surface of the substrate by means of an adhesive paste and a firing process. The electrical conductor path is applied to an electrically insulating plate-shaped membrane, which has a thickness in the range of 1 to 50 μm and is firmly connected to the base portion areas. The membrane can be made as a glass layer 10 to 50 μm thick. It is, however, also possible to use a membrane comprising an SiO film deposited by thin-film technology, having a thickness of 1 to 10 μm, preferably 2 μm. The conductor path is applied in the form of a meander at least in the area between the base portions, wherein the respective return zones of the meander are arranged above the base portions, while the intermediate stretches of the meander span over a recess in the substrate or over the substrate surface in a bridge-like fashion. A special advantage in this case is the fact that the thermal inertia of the system is very low, and thereby provides a very small response time in the millisecond range.

The conductor path is preferably made of a platinum film or platinum foil with a thickness of 0.3 to 3 μm, preferably 0.5 μm. This proves to be particularly advantageous in that, because of the small mass of the structure, the sensor signal follows the rapidly changing measurement parameters almost without inertia.

In another preferred embodiment of the resistance arrangement according to the invention, the conductor path is made of a gold film, having a thickness of 1 to 8 μm, preferably 2 to 3 μm. The manufacture of a structured gold film proves to be advantageous, since galvanic deposition processes are known per se, which allow fine structures to be obtained by using various prior art processes.

In a further advantageous embodiment of the resistance arrangement, the electric conductor path is applied to a plate-shaped membrane, at least partially covering the recess or the surface area of the substrate, wherein the membrane has a thickness of 1 to 50 μm. This proves to be advantageous due to the higher stability of the conductor path, as can be required in applications where severe mechanical loading occurs, e.g., vibrations in motor vehicle engines.

The membrane is made either of a glass layer, having a thickness of 10 to 50 μm, or preferably of an SiO or TiO₂ or Al₂O₃ layer (or a combination of these materials), deposited in a thin-film process to have a thickness of 1 to 10 μm, preferably 2 μm. Owing to the relatively thin membrane, a low thermal inertia and consequently a rapid responsiveness are advantageously guaranteed.

In another advantageous embodiment, the conductor path is provided on the substrate with a skin layer of an electrically insulating material, which has a thickness of 1 to 50 μm. The conductor path is thereby protected, in particular in an aggressive environment, so that long-term stability is increased. The skin layer of the conductor path is made either of glass, with the thickness of the glass skin layer in a range of 10 to 50 μm, or of a layer applied by the thin-film technology, wherein the skin layer advantageously comprises an SiO layer having a thickness of 1 to 10 μm, preferably 2 μm. On account of the relatively thin skin layer, a rapid responsiveness as a the temperature-measuring resistor is achieved, wherein its outer surface is protected against interference from the surrounding atmosphere.

The object of the invention is further achieved by providing a process for manufacture of a resistance, in particular a measuring resistor for a rapid-response temperature sensor, on a substrate with an electrically insulating surface, wherein the substrate has a ceramic surface, which has at least two spaced-apart surface areas selectively printed (metallized) with an adhesive paste (metal coating), wherein a base blank made of metal is applied to these surface areas and is mechanically firmly attached to the substrate at these surface areas by firing. The side of the base blank facing away from the substrate has a planar form. The blank is provided with a planar membrane of glass, applied by screen printing, or of an SiO, TiO₂, or Al₂O₃ layer or a combination thereof, applied by thin-film technology. Following thereon, a layer for the conductor path made of platinum or gold is applied on top of the membrane galvanically or by a thin-film process (PVD-process). After structuring the platinum or gold layer to a conductor path by using a conventional method, e.g., photolithography and ion etching for platinum or galvanic build-up for gold, a passivating layer is selectively printed on the conductor path (screen printing with glass) or applied by a PVD-process (with SiO). Finally, the area of the membrane layer (including the conductor path and the passivating layer) are photolithographically coated from above, and in a first etching step, the base blank is so etched that it assumes the shape of the membrane (i.e., base portion areas over the metallization areas, which are connected to each other by a bridge for the conductor path).

For a second etching step, the part of the base blank which is located above the adhesive agent areas or the metallized areas is then coated proceeding out over the edge area, while the bridge-shaped middle part of the blank, which is between the metallized areas, as well as the built-up layers (membrane, conductor path, and passivating layer) located on top of them remain exposed. Subsequently, the non-adhering middle part of the base blank is etched away to form a gap (free space) between the membrane and the surface of the ceramic substrate.

In a preferred embodiment of the process, the adhesive paste (about 10 μm thick) is selectively printed in a screen-printing process in the form of individual points spaced from each other on the ceramic surface of the substrate (ceramic thickness of about 0.635 mm); after the application of the base blank of copper or nickel, this is integrally bonded to the substrate by a firing process to the two spaced-apart metallized areas (areas with adhesive paste). The non-adhering area of the base blank is then later etched away, as described above, so that after the etching step, two spaced-apart metal (Cu or Ni) base portions remain.

In a preferred embodiment of the process, the membrane is applied in a screen printing process as a glass membrane or in a thin-film process (Physical Vapor Deposition or PVD-process) as a thin-film membrane of SiO on the surface of the base blank. Consequently, conventional coating techniques can advantageously be used. In addition, the structured skin layer is also later applied on the conductor path in a screen printing process as glass or in a PVD-process as a thin-film layer of SiO.

In a further advantageous embodiment of the process, the membrane layer is selectively deposited from the vapor phase in a first PVD process with a metallic vapor-deposition mask. The thickness of this layer is preferably 2 to 3 μm.

Subsequently, a PVD Pt deposition is carried out over the entire surface in a preferred thickness of 0.5 to 0.6 μm, which is then structured photolithographically, according to the prior art, to a conductor path with connecting contacts. A passivating layer is then selectively applied by a PVD-process, which is preferably made of SiO with a thickness of 2 to 3 μm. After the above-described etching steps, the photoresist is removed, and finally the individual part is fed to a saw for the separation process.

After the separation into individual parts, for example, Pt wires are contacted and provided with a low-temperature fixation. This rapid-response sensor component is usable in the temperature range of −50° C. to +220° C. with the copper base portions and up to 500° C. with the nickel base portions. The insulation resistance of the conductor path structure to the supporting metallic base portions, according to an exemplary embodiment, amounts to 200 MOhm.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiment(s) which are presently preferred. It should be understood, however, that the invention is not limited to the precise arrangements and instrumentalities shown. In the drawings:

FIG. 1 is a schematic representation, in a perspective view, of a ceramic substrate with the selectively applied adhesive coating;

FIG. 2 shows the ceramic substrate with the deposited base blank, wherein the blank covers the entire surface of the substrate and thus both spaced-apart fields of the adhesive coating;

FIG. 3a shows the layer build-up on the base blank;

FIG. 3b shows sectionally in longitudinal profile the layer build-up;

FIG. 4 shows the covering of the base blank in a coating area (membrane, conductor path, passivating layer), wherein in the middle part only the built-up layers are covered, and the rest remain without cover and thus exposed for etching;

FIG. 5 shows the base blank exposed in the first etching step, wherein underneath the middle part of the conductor path a bridge-like, massive structure of the blank is still present, which is coated by a screen printing paste over the metallized areas of the base blanks proceeding over their edge area for a second etching step for removal of the bridge-forming middle part;

FIG. 6 shows the finished measuring resistor obtained after the second etching step, in a perspective view;

FIG. 7 is a cross-sectional view taken along plane AA in FIG. 6, and with connecting wires attached; and

FIG. 8 is a voltage diagram over time showing the measurement responsiveness of a measuring resistance of the invention at various temperatures.

### DETAILED DESCRIPTION OF THE INVENTION

As shown in FIG. 1, the ceramic substrate 1 has a rectangular block form with a planar electrically insulating surface 2, on which two spaced-apart areas 3, 4 are coated with an adhesive agent, whose thickness lies in the order of 10 μm. The thickness of the substrate 1, preferably made of aluminum oxide, is in the range of 0.6 to 0.8 mm, preferably 0.635 mm. As adhesive agent for the areas 3, 4, preferably a CuTi paste is applied.

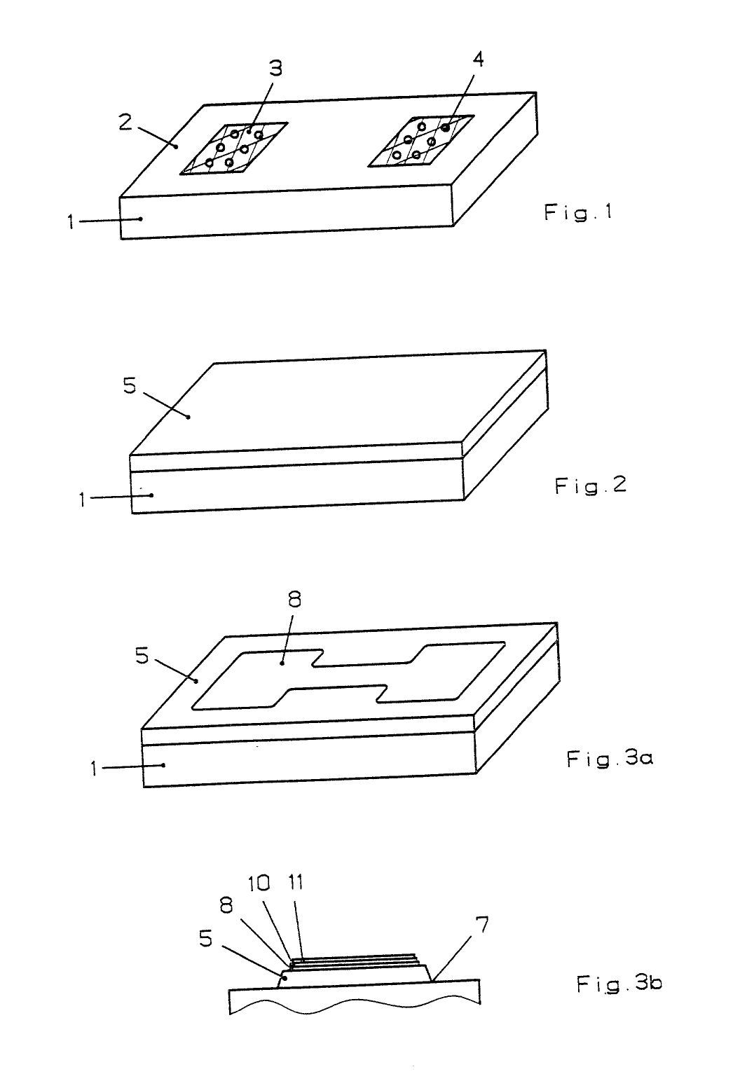

As shown in FIG. 2, a base blank 5 in the form of a rectangular sheet is applied to the full surface, so as to cover completely both the areas 3, 4 as well as the surface 2 of the substrate 1. Next, the base blank is bonded to the substrate 1 over the metallized areas 3, 4 by a firing step at a temperature on the order of 750° C. The thickness of the substrate 1 is in the range of 0.6 to 0.8 mm, preferably 0.635 mm, and the thickness of the blank is in the range of 0.18 mm to 0.22 mm, preferably 0.2 mm.

As shown in FIG. 3a, in a first PVD step, a membrane layer 8, which preferably comprises SiO, is selectively deposited through a metallic vapor deposition mask on the outer surface 7 of the blank 5. As shown in detail in FIG. 3b, this is followed by a platinum layer 10, which is deposited in a PVD process on the membrane layer 8 for later forming the conductor path, wherein the platinum layer has a thickness in a range of 0.4 to 1.5 μm, preferably 0.5 μm. Subsequently, the applied platinum layer is photolithographically structured according to a prior art process, in order to obtain, for example, a meander shape which is characteristic of the measuring resistors. After the structuring step, as schematically shown in FIG. 3b, a passivating layer 11 is selectively applied in a PVD-process, which is preferably made of SiO and has a thickness in the range of 2 to 3 μm.

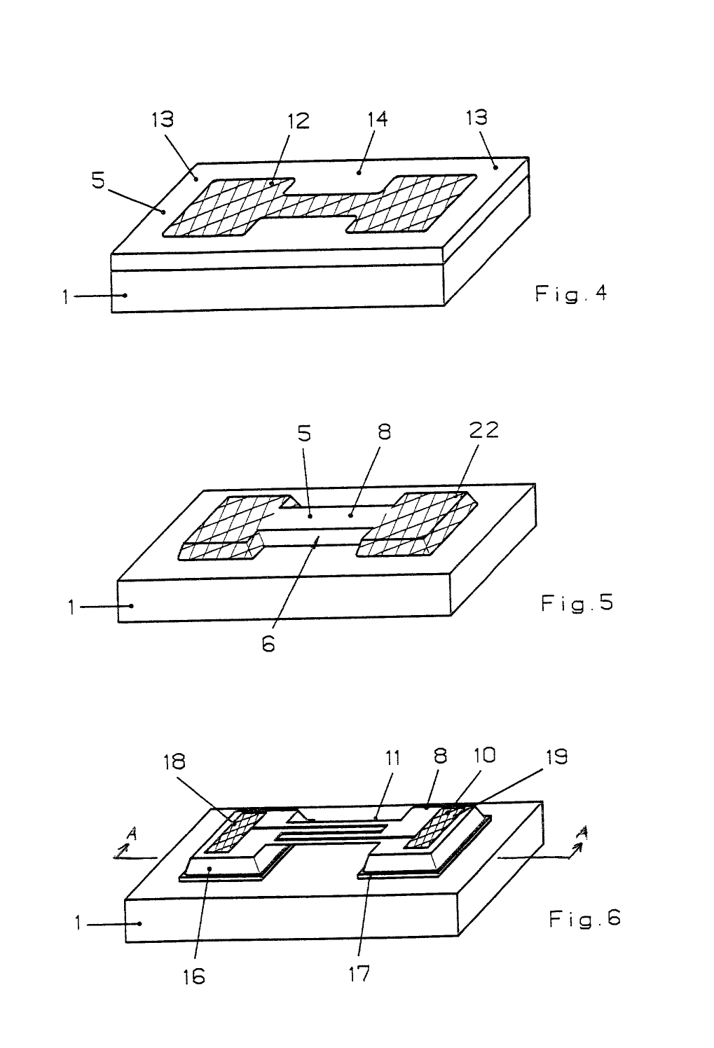

As shown in FIG. 4, an etching mask 12 made of a photoresist is applied on the base blank 5 and is photolithographically structured, so that the base blank, together with the layers applied to its surface, is covered in the outline of the membrane layer 8, while the remaining area 13 is exposed. Subsequently, in a first etching step, the edge and intermediate areas 13, 14 are etched away, such that the layered structure formed by the membrane 8, platinum layer 10, and passivating layer 11 covers the blank.

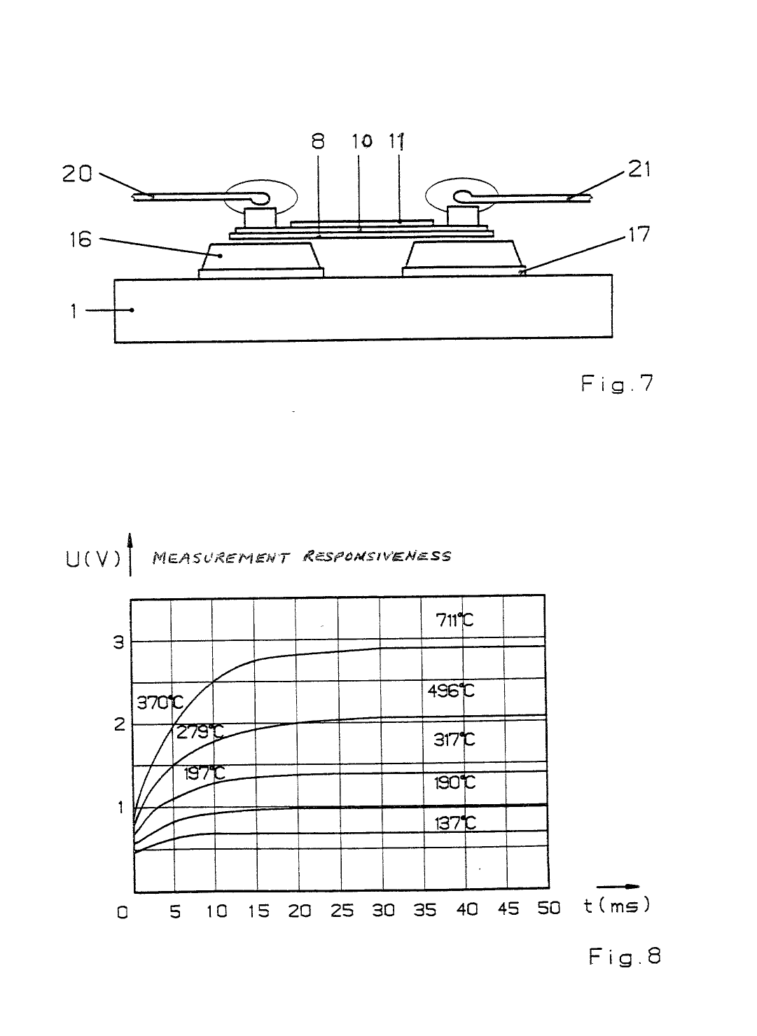

As shown in FIG. 5, the base blank 5 obtained after the first etching step, together with the applied layers 8, 10, and 11, with the exception of the middle part 6, is covered by applying a new screen printed layer 22 outwardly over the edge areas, wherein in a second etching step, the middle part 6 of the blank, found in the intermediate area between the membrane layer 8 and the surface 2 of the substrate, is etched away. As shown in FIG. 6, only base portions 16, 17 over the metallized areas 3, 4 remain, between which the layer build-up with the layers 8, 10, and 11 spans them in a bridge-like manner, while on the base portions 16, 17 additionally, the connecting contact fields 18, 19 of the conductor path can be provided with connection wires.

As etching agent for both the first and second etching steps, an FeCl₃/HCl solution can be used.

The finished form shown in FIG. 6 is illustrated in longitudinal section along plane A-A in FIG. 7. FIG. 7 shows the membrane layer 8 lying on the base portions 16, 17, the membrane layer being shown here in a raised position for the sake of clarity. The membrane layer 8 supports the platinum layer 10, which is now present as a structured conductor path, which is connected to lead wires 20, 21 in the area of its contact fields. The platinum layer conductor path 10 is, in turn, covered by the passivating layer 11.

FIG. 8 shows a voltage diagram over time, with which the dynamic behavior of the measuring resistor or the voltage drop across the resistor is illustrated. The following values are plotted:

| | |
|---|---|
| Y-axis: | Voltage (0.5 V/div.) |
| X-axis: | Time (5 ms/div.) |

The conductor path 10 consists of a platinum meander between two SiO layers 8, 11 (2-μm each), from which the sensor data are as follows:

| | |
|---|---|
| Ro = | 9.17 Ω(ohm) |
| R100 = | 12.70 Ω(ohm) |
| Tk = | 3845 ppm/K |

Measurement results:

| I (mA) | U (V) | R (Ω) | T (° C.) | t 50% (ms) | t 90% (ms) |
|---|---|---|---|---|---|
| 90 | 2.87 | 31.94 | 711 | 5 | 15 |
| 80 | 2.05 | 25.63 | 496 | 5 | 15 |
| 70 | 1.41 | 20.02 | 317 | 5 | 15 |
| 60 | 0.95 | 15.81 | 190 | 5 | 15 |
| 50 | 0.7 | 14 | 137 | 5 | 15 |

It will be appreciated by those skilled in the art that changes could be made to the embodiment(s) described above without departing from the broad inventive concept thereof. It is understood, therefore, that this invention is not limited to the particular embodiment(s) disclosed, but it is intended to cover modifications within the spirit and scope of the present invention as defined by the appended claims.

We claim:

1. An electrical resistor, particularly a temperature-dependent resistor having a rapid response time, comprising an electrical conductor path provided with at least two connection contact fields, which are respectively mechanically firmly connected to a substrate having an electrically insulating surface, wherein a portion of the conductor path spans at least one area of the substrate (1) and the conductor path is arranged in a plane, and wherein the conductor path (10) is firmly connected to the substrate (1) by at least two spaced-apart base portions (16, 17).

2. The electrical resistor of claim 1, wherein at least the surface of the substrate comprises a ceramic.

3. The electrical resistor of claim 1, wherein the base portions (16, 17) comprise a metal and are mechanically firmly connected to the surface (2) of the substrate (1) by a metallic adhesive paste and a firing process.

4. The electrical resistor of claim 3, wherein the base portions comprise copper or nickel.

5. The electrical resistor of claim 1, wherein the electrical conductor path (10) is supported by a plate-shaped membrane (8) having a thickness of 1 to 50 μm and is firmly connected to the base portions (16,17).

6. The electrical resistor of claim 5, wherein the membrane (8) comprises a glass layer having a thickness of 10 to 50 μm.

7. The electrical resistor of claim 5, wherein the membrane (8) comprises a layer selected from the group consisting of SiO, TiO₂, Al₂O₃ and combinations thereof applied by thin-film technology and having a thickness of 1 to 10 μm.

8. The electrical resistor of claim 1, wherein the conductor path (10) has a form of a meander, at least in an area between the base portions, wherein respective return sections of the meander are arranged in an area above the base portions, while intermediate stretches of the meander span a recess between the base portions in a bridge-like fashion.

9. The electrical resistor of claim 1, wherein the conductor path (10) comprises a platinum layer or foil.

10. The electrical resistor of claim 9, wherein the platinum layer or foil has a thickness of 0.3 to 1.5 μm.

11. The electrical resistor of claim 1, wherein the conductor path (10) comprises a gold layer.

12. The electrical resistor of claim 11, wherein the gold layer has a thickness of 1 to 8 μm.

13. The electrical resistor of claim 1, wherein the conductor path (10) is has a passivating layer (11) comprising an electrically insulating material, having a thickness of 1 to 50 μm.

14. The electrical resistor of claim 13, wherein the passivating layer (11) comprises glass.

15. The electrical resistor of claim 14, wherein the passivating layer (11) has a thickness of 10 to 50 μm.

16. The electrical resistor of claim 13, wherein the passivating layer (11) comprises a layer applied by thin-film technology.

17. The electrical resistor of claim 16, wherein the passivating layer (11) comprises a layer of SiO, having a thickness of 1 to 10 μm.

18. The electrical resistor of claim 1, wherein the substrate has a recess between the base portions (16, 17), and a membrane (8) supporting the conductor path and spanning the recess.

19. A process for making an electrical resistor, particularly a measuring resistor for rapid-response temperature sensors on a substrate having an electrically insulating surface, comprising providing a substrate (1) having a ceramic surface (2), printing at least two spaced-apart surface areas (3, 4) of the substrate with an adhesive paste, applying a covering metal base blank (5) over these surface areas (3, 4) and mechanically firmly connecting the base blank to the substrate (1) over the surface areas (3, 4) by firing, making the side of the base blank (5) facing away from the substrate (1) planar and applying a planar membrane layer (8) by screen printing or by a thin-film technique to said surface of the base blank, subsequently applying to the membrane layer (8) a conductor path layer (10) selected from the group consisting of platinum by a thin-film technique or gold by a galvanic process, structuring the conductor path layer (10) to provide connection contacts for the conductor path, covering the conductor path layer (10) with an electrically insulating passivating layer (11), photolithographically covering from above a conductor plate structure comprising the layers (8, 10, 11) in an outline of the membrane layer (8) and etching away the base blank surrounding this outline in a first etching step, and in a second etching step etching away a non-bonded middle portion of the base blank between bonded portions formed by the firing step between the conductor plate strucure and the substrate from the substrate surface (2) up to the membrane (8) to form a gap between the membrane (8) and the ceramic surface (2).

20. The process of claim 19, wherein the membrane (8) is applied to the surface (2) of the substrate by screen printing as a glass membrane or by thin-film technology as a thin-film membrane of SiO.

21. The process of claim 18, wherein the passivating layer (11) is applied to the conductor path layer (10) by screen printing with glass or by thin-film technology with SiO.

22. The process of claim 18, wherein the conductor path (10) is applied by a thin-film technique and is structured by photolithography, ion etching, and removal of a photoresist.

23. The process of claim 18, wherein the conductor path (10) is galvanically deposited in a resist channel on a preliminarily applied metal electrode, and the metal electrode is subsequently removed chemically or by a dry etching process.

24. The process of claim 18, wherein the conductor path (10) is deposited in a photolithographically prepared resist channel by a PVD process, with subsequent removal of the photoresist.
